(19) United States
(12) Patent Application Publication
(10) Pub. No.: US 2018/0329282 A1
(43) Pub. Date: Nov. 15, 2018

(54) LIGHT SOURCE APPARATUS AND PROJECTOR

(71) Applicant: SEIKO EPSON CORPORATION, Tokyo (JP)

(72) Inventor: Koichi AKIYAMA, Matsumoto-Shi (JP)

(73) Assignee: SEIKO EPSON CORPORATION, Tokyo (JP)

(21) Appl. No.: 15/969,455

(22) Filed: May 2, 2018

(30) Foreign Application Priority Data
May 10, 2017 (JP) 2017-094051

(51) Int. Cl. G03B 21/20

(52) U.S. Cl. CPC G03B 21/204; G03B 21/2013; G03B 21/2073; G03B 21/208; G03B 21/2093

(57) ABSTRACT

A light source apparatus according to an aspect of the invention includes a light source unit including a light source section that includes a plurality of semiconductor laser devices and a collimation system, a light beam flux compression system, and a homogenizing system. In a position upstream of the light beam flux compression system, a major axis direction and a minor axis direction of the cross section of each of the plurality of laser light beams are so defined that one of the two directions in which the light beam flux is thicker than in the other direction is a first direction, and the direction in which the light beam flux compression system has maximum refractive power is defined as a maximum refraction direction, and the angle between the maximum refraction direction and the first direction is greater than 0° but smaller than 45°.

### BACKGROUND

### 1. Technical Field

The present invention relates to a light source apparatus and a projector.

### 2. Related Art

For example, as a light source apparatus used in a projector, a light source apparatus using a laser device and a phosphor has been proposed. JP-A-2014-182358 discloses a light source apparatus including a light source section including a plurality of laser light source groups and a plurality of mirror groups, and a fluorescence generator including a convex lens, a concave lens, multi-lens arrays, a dichroic mirror, a light collection lens, and a phosphor wheel. In the light source apparatus, a plurality of light beams emitted from the plurality of laser light source groups are combined with one another by the plurality of mirror groups, and the combined light beam flux passes through the convex lens and the concave lens, which reduce the width of the combined light beam flux, and is then incident on the phosphor wheel.

In the light source apparatus disclosed in JP-A-2014-182358, since the cross section of the light beam flux formed of the plurality of light beams outputted from the light source section has a long side direction and a short side direction, the light collection lens, on which the light beam flux is incident, has a useless area, undesirably resulting in an increase in the size of the light collection lens. Further, depending on the inter-lens interval of the multi-lens arrays, it is undesirably difficult to achieve a uniform illuminance distribution of excitation light on the phosphor.

### SUMMARY

An advantage of some aspects of the invention is to provide a light source apparatus that allows reduction in the size thereof and provides highly uniform illuminance distribution in an illuminated area. Another advantage of some aspects of the invention is to provide a projector including the light source apparatus.

A light source apparatus according to an aspect of the invention includes a light source unit including a light source section that includes a plurality of semiconductor laser devices and outputs a light beam flux formed of a plurality of laser light beams and a collimation system that parallelizes the light beam flux, the light source unit outputting the parallelized light beam flux, an anamorphic light beam flux compression system on which the light beam flux outputted from the light source unit is incident, and a homogenizing system formed of a first lens array, a second lens array, and a light collection lens provided in positions downstream of the light beam flux compression system in an order of the first lens array, the second lens array, and the light collection lens. In a position upstream of the light beam flux compression system, a major axis direction and a minor axis direction of a cross section of each of the plurality of laser light beams are so defined that one of the two directions in which the light beam flux is thicker than in another direction is a first direction, and a direction in which the light beam flux compression system has maximum refractive power is defined as a maximum refraction direction, and an angle between the maximum refraction direction and the first direction is greater than 0° but smaller than 45°.

In the light source apparatus according to the aspect of the invention, since the angle between the maximum refraction direction of the light beam flux compression system and the first direction of the light beam flux is greater than 0° but smaller than 45°, the light beam flux in a position downstream of the light beam flux compression system is narrower than the light beam flux in a position upstream of the light beam flux compression system, and the arrangement of the spots of the plurality of laser light beams that form the light beam flux is distorted. The thus configured light beam flux is incident on the first lens array of the homogenizing system. As a result, the size of each optical system downstream of the light beam flux compression system can be reduced, and the uniformity of the illuminance distribution of the light beam flux can be increased.

In the light source apparatus according to the aspect of the invention, the plurality of semiconductor laser devices may each have a light emitting area having a long side direction and a short side direction, and the first direction may be parallel to one of the long side direction and the short side direction.

According to the configuration described above, a light source section having a simple configuration can be provided.

In the light source apparatus according to the aspect of the invention, the light beam flux compression system may include a first cylindrical lens having positive refracting power and a second cylindrical lens provided in a position downstream of the first cylindrical lens, and a direction of a generatrix of the first cylindrical lens may be parallel to a direction of a generatrix of the second cylindrical lens.

According to the configuration described above, a light beam flux compression system having refracting power only in one direction can be configured.

In the light source apparatus according to the aspect of the invention, the angle between the maximum refraction direction and the first direction may be greater than or equal to 5° but smaller than or equal to 35°.

According to the configuration described above, the uniformity of the illuminance distribution of the light beam flux can be further increased.

In the light source apparatus according to the aspect of the invention, the angle between the maximum refraction direction and the first direction may be greater than or equal to 5° but smaller than or equal to 15°.

According to the configuration described above, the reduction in size of each optical system in a position downstream of the light beam flux compression system and the uniform illuminance distribution can both be sufficiently achieved.

In the light source apparatus according to the aspect of the invention, the first lens array may have a plurality of lens rows each formed of a plurality of lenses, and a boundary line between two lens rows adjacent to each other out of the plurality of lens rows may incline with respect to the first direction by 0° or 90°.

According to the configuration described above, the uniformity of the illuminance distribution of the light beam flux can be further increased.

The light source apparatus according to the aspect of the invention may further include a wavelength converter provided in a position downstream of the homogenizing system.

According to the configuration described above, illumination light having a desirable color can be provided.

A projector according to another aspect of the invention includes the light source apparatus according to the aspect of the invention, a light modulator that modulates light from the light source apparatus in accordance with image information to form image light, and a projection system that projects the image light.

According to the aspect of the invention, a compact projector that excels in image quality can be achieved.

### BRIEF DESCRIPTION OF THE DRAWINGS

The invention will be described with reference to the accompanying drawings, wherein like numbers reference like elements.

FIG. 1 is a schematic configuration diagram of a projector according to an embodiment of the invention.

FIG. 2 is a schematic configuration diagram of a light source apparatus according to the embodiment of the invention.

FIG. 3 is a perspective view of a light source unit.

FIG. 4 is a perspective view of a semiconductor laser device.

FIG. 5 is aside view of key parts of the light source apparatus viewed in a direction of X axis.

FIG. 6 is a plan view of the key parts of the light source apparatus viewed in a direction of Z axis.

FIG. 7 shows the cross section of a light beam flux in a position upstream of a light beam flux compression system and the angle of rotation of the light beam flux compression system.

FIG. 8A shows the cross section of the light beam flux in a position downstream of the light beam flux compression system in a case where the angle of rotation of the light beam flux compression system is 0°.

FIG. 8B shows the illuminance distribution in an illuminated area in the case where the angle of rotation of the light beam flux compression system is 0°.

FIG. 8C shows graphs representing the illuminance distributions in the illuminated area in the case where the angle of rotation of the light beam flux compression system is 0°.

FIG. 9A shows the cross section of the light beam flux in the position downstream of the light beam flux compression system in a case where the angle of rotation of the light beam flux compression system is 5°.

FIG. 9B shows the illuminance distribution in the illuminated area in the case where the angle of rotation of the light beam flux compression system is 5°.

FIG. 9C shows graphs representing the illuminance distributions in the illuminated area in the case where the angle of rotation of the light beam flux compression system is 5°.

FIG. 10A shows the cross section of the light beam flux in the position downstream of the light beam flux compression system in a case where the angle of rotation of the light beam flux compression system is 10°.

FIG. 10B shows the illuminance distribution in the illuminated area in the case where the angle of rotation of the light beam flux compression system is 10°.

FIG. 10C shows graphs representing the illuminance distributions in the illuminated area in the case where the angle of rotation of the light beam flux compression system is 10°.

FIG. 11A shows the cross section of the light beam flux in the position downstream of the light beam flux compression system in a case where the angle of rotation of the light beam flux compression system is 15°.

FIG. 11B shows the illuminance distribution in the illuminated area in the case where the angle of rotation of the light beam flux compression system is 15°.

FIG. 11C shows graphs representing the illuminance distributions in the illuminated area in the case where the angle of rotation of the light beam flux compression system is 15°.

FIG. 12A shows the cross section of the light beam flux in the position downstream of the light beam flux compression system in a case where the angle of rotation of the light beam flux compression system is 20°.

FIG. 12B shows the illuminance distribution in the illuminated area in the case where the angle of rotation of the light beam flux compression system is 20°.

FIG. 12C shows graphs representing the illuminance distributions in the illuminated area in the case where the angle of rotation of the light beam flux compression system is 20°.

FIG. 13A shows the cross section of the light beam flux in the position downstream of the light beam flux compression system in a case where the angle of rotation of the light beam flux compression system is 25°.

FIG. 13B shows the illuminance distribution in the illuminated area in the case where the angle of rotation of the light beam flux compression system is 25°.

FIG. 13C shows graphs representing the illuminance distributions in the illuminated area in the case where the angle of rotation of the light beam flux compression system is 25°.

FIG. 14A shows the cross section of the light beam flux in the position downstream of the light beam flux compression system in a case where the angle of rotation of the light beam flux compression system is 30°.

FIG. 14B shows the illuminance distribution in the illuminated area in the case where the angle of rotation of the light beam flux compression system is 30°.

FIG. 14C shows graphs representing the illuminance distributions in the illuminated area in the case where the angle of rotation of the light beam flux compression system is 30°.

FIG. 15A shows the cross section of the light beam flux in the position downstream of the light beam flux compression system in a case where the angle of rotation of the light beam flux compression system is 35°.

FIG. 15B shows the illuminance distribution in the illuminated area in the case where the angle of rotation of the light beam flux compression system is 35°.

FIG. 15C shows graphs representing the illuminance distributions in the illuminated area in the case where the angle of rotation of the light beam flux compression system is 35°.

FIG. 16A shows the cross section of the light beam flux in the position downstream of the light beam flux compression system in a case where the angle of rotation of the light beam flux compression system is 40°.

FIG. 16B shows the illuminance distribution in the illuminated area in the case where the angle of rotation of the light beam flux compression system is 40°.

FIG. 16C shows graphs representing the illuminance distributions in the illuminated area in the case where the angle of rotation of the light beam flux compression system is 40°.

FIG. 17A shows the cross section of the light beam flux in the position downstream of the light beam flux compression system in a case where the angle of rotation of the light beam flux compression system is 45°.

FIG. 17B shows the illuminance distribution in the illuminated area in the case where the angle of rotation of the light beam flux compression system is 45°.

FIG. 17C shows graphs representing the illuminance distributions in the illuminated area in the case where the angle of rotation of the light beam flux compression system is 45°.

### DESCRIPTION OF EXEMPLARY EMBODIMENTS

An embodiment of the invention will be described below in detail with reference to the drawings.

In the drawings used in the following description, a characteristic portion is enlarged for convenience in some cases for clarity of the characteristic thereof, and the dimension ratio and other factors of each component are therefore not always equal to actual values.

### Projector

A projector according to the present embodiment will be described.

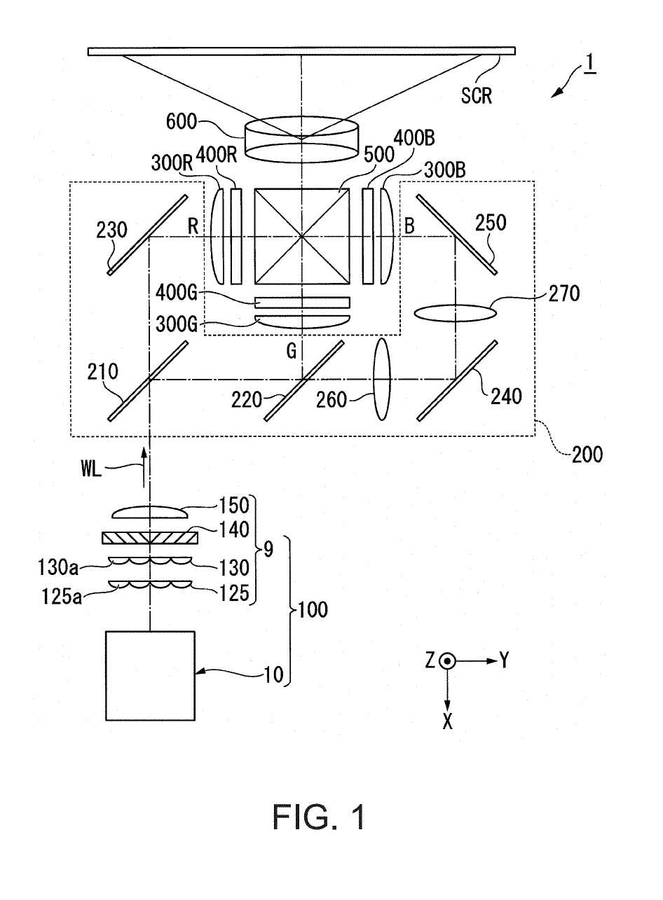

FIG. 1 is a schematic configuration diagram of a projector 1 according to the present embodiment.

The projector 1 includes an illuminator 100, a color separation/light guide system 200, light modulators 400R, 400G, and 400B, a cross dichroic prims 500, and a projection system 600, as shown in FIG. 1.

In the present embodiment, the illuminator 100 outputs white illumination light WL toward the color separation/light guide system 200. The illuminator 100 includes a homogenized illumination system 9 and a light source apparatus 10.

The color separation/light guide system 200 includes dichroic mirrors 210 and 220, reflection mirrors 230, 240, and 250, and relay lenses 260 and 270. The color separation/light guide system 200 separates the light outputted from the illuminator 100 into red light, green light, and blue light and guides the red light, the green light, and the blue light to the corresponding light modulators 400R, 400G, and 400B.

A field lens 300R is disposed between the color separation/light guide system 200 and the light modulator 400R. A field lens 300G is disposed between the color separation/light guide system 200 and the light modulator 400G. A field lens 300B is disposed between the color separation/light guide system 200 and the light modulator 400B.

The dichroic mirror 210 transmits the red light and reflects the green light and the blue light. The dichroic mirror 220 reflects the green light and transmits the blue light. The reflection mirror 230 reflects the red light. The reflection mirrors 240 and 250 reflect the blue light.

The light modulators 400R, 400G, and 400B modulate the color light fluxes incident thereon in accordance with image information to form a color image Although not shown, light-incident-side polarizers are disposed between the field lenses 300R, 300G, 300B and the light modulators 400R, 400G, 400B. Light-exiting-side polarizers are disposed between the light modulators 400R, 400G, 400B and the cross dichroic prism 500.

The cross dichroic prism 500 combines the image light fluxes outputted from the light modulators 400R, 400G, and 400B with one another. The cross dichroic prism 500 is formed by bonding four rectangular prisms to each other and therefore has a roughly square shape in a plan view, and dielectric multilayer films are formed along the roughly X-letter-shaped interfaces between the bonded rectangular prisms.

The combined image light having exited out of the cross dichroic prism 500 is enlarged and projected by the projection system 600 and forms an image on a careen SCR.

### Light Source Apparatus

The configuration of the light source apparatus 10 will be described.

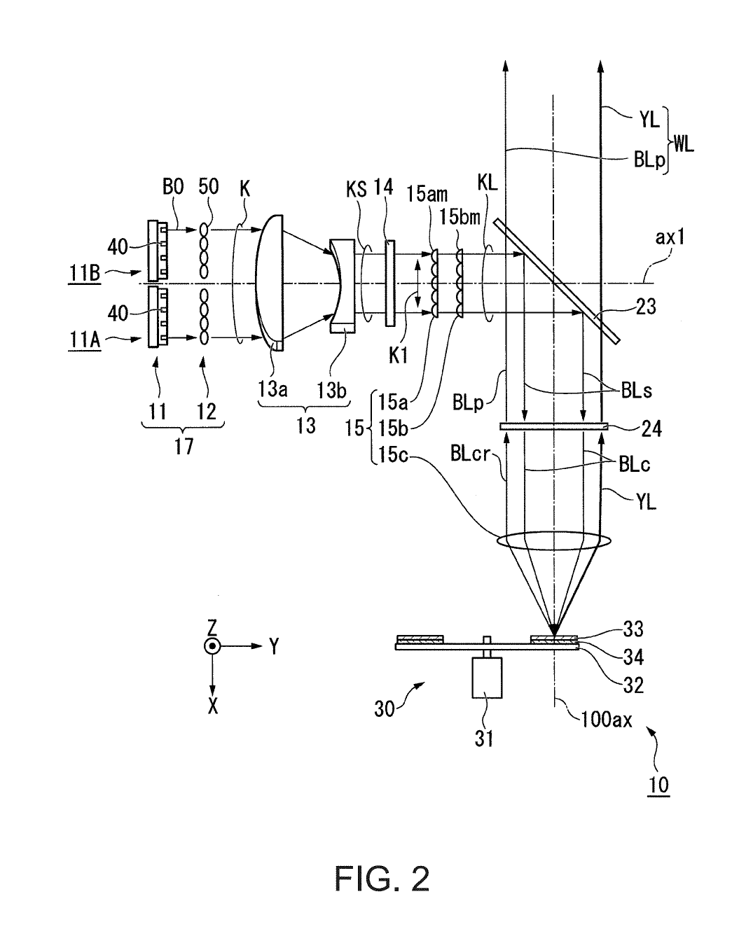

FIG. 2 is a schematic configuration diagram of the light source apparatus 10.

The light source apparatus 10 includes alight source unit 17, a light beam flux compression system 13, a half wave plate 14, a homogenizing system 15, a polarization separation element 23, a retardation film 24, and a wavelength converter 30, as shown in FIG. 2.

The light source unit 17 includes a light source section 11 and a collimation system 12. The light beam flux compression system 13 includes a first cylindrical lens 13a and a second cylindrical lens 13b. The homogenizing system 15 includes a first lens array 15a, a second lens array 15b, and a light collection lens 15c.

The following description using the drawings will be made by using an XYZ coordinate system. The direction X is the direction parallel to an illumination optical axis 100ax in the light source apparatus 10. The direction Y is the direction parallel to an optical axis ax1 of the light source section 11. The direction Z is the direction perpendicular to the directions X and Y.

The light source section 11, the collimation system 12, the light beam flux compression system 13, the half wave plate 14, the first lens array 15a, the second lens array 15b, and the polarization separation element 23 are arranged in this order along the optical axis ax1. The wavelength converter 30, the light collection lens 15c, the retardation film 24, and the polarization separation element 23 are arranged in this order along the illumination optical axis 100ax.

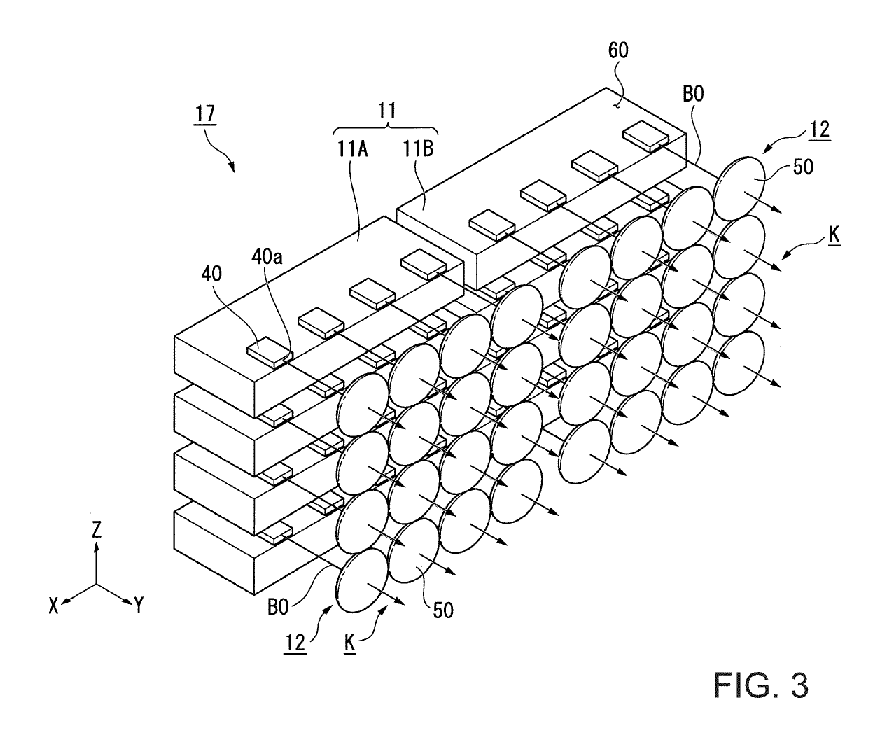

FIG. 3 is a perspective view showing the configuration of the light source unit 17.

In the light source unit 17, the light source section 11 includes a first light source section 11A and a second light source section 11B, as shown in FIG. 3. The first light source section 11A and the second light source section 11B are arranged side by side along the direction X.

The first light source section 11A and the second light source section 11B have the same configuration, and the structure of the first light source section 11A is therefore described below.

The first light source section 11A includes a plurality of semiconductor laser devices 40 and a plurality of support members 60. The plurality of semiconductor laser devices 40 are supported by the support members 60. Each of the support members 60 is a plate-shaped member and made of a metallic material that excels in heat dissipation, such as aluminum and copper.

The semiconductor laser devices 40 each emit a blue laser light beam B0. The semiconductor laser devices 40 each have an emission intensity peak wavelength of, for example, 445 nm. The polarization direction of each of the laser light beams B0 is so set that the laser light beam B0 is reflected off the polarization separation element 23.

In the present embodiment, 4 semiconductor laser devices 40 are provided on the upper surface of one support member 60 along the direction X at predetermined intervals. Further, 4 support members 60 on each of which the 4 semiconductor lasers 40 are provided are provided along the direction Z at predetermined intervals. That is, the first light source section 11A includes 16 semiconductor laser devices 40 arranged in 4 rows by 4 columns in a plane parallel to the plane XZ. The second light source section 11B includes semiconductor laser devices 40 arranged in the plane parallel to the plane XZ, as the first light source section 11A does. That is, the light source section 11 includes 32 semiconductor laser devices 40 arranged in the plane parallel to the plane XZ.

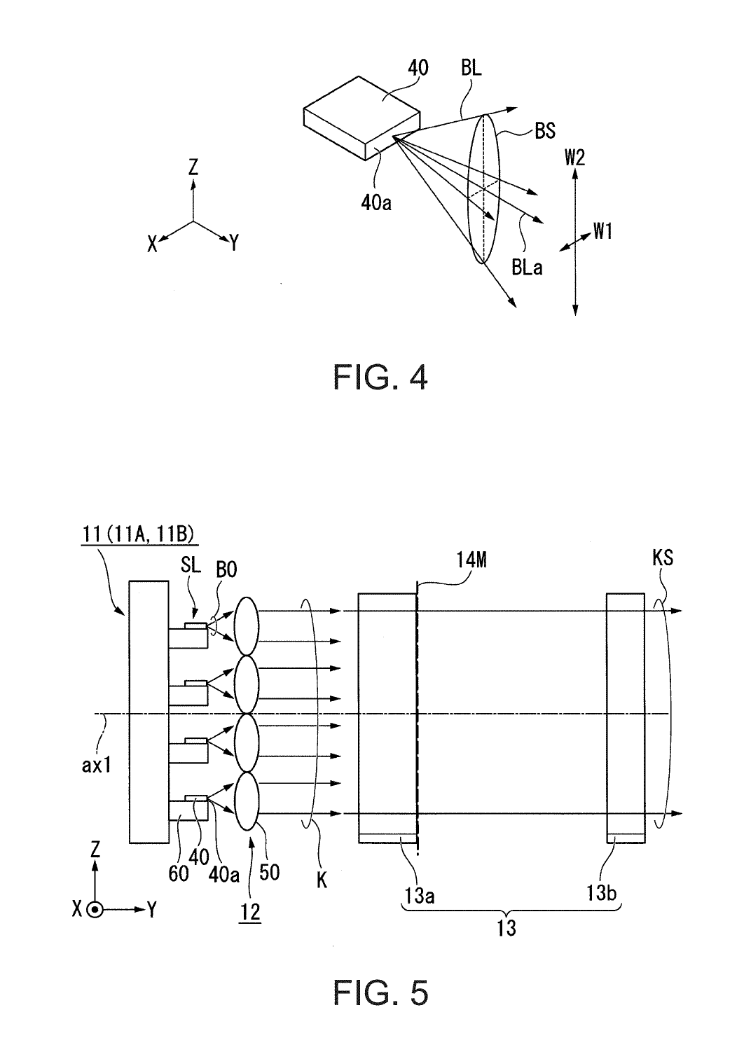

FIG. 4 is a perspective view of each of the semiconductor laser devices 40.

The semiconductor laser devices 40 each have a light emitting area 40a, from which light is emitted, as shown in FIG. 4. The light emitting area 40a has a roughly rectangular plan shape when viewed in the direction of a principal ray BLa of the emitted laser light beam B0 and has a long side direction W1 and a short side direction W2. The long side direction W1 is parallel to the direction X, and the short side direction W2 is parallel to the direction Z.

The laser light beam B0 emitted from each of the semiconductor laser devices 40 is formed of a linearly polarized light and has a polarization direction parallel to the long side direction W1 (direction X). The polarization direction of the laser light beam B0 is converted by the half wave plate 14 into the direction parallel to the short side direction (direction Z). The laser light beam B0 is therefore reflected off the polarization separation element 23. The angle of divergence of the laser light beam B0 in the short side direction W2 is greater than the angle of divergence of the light beam B0 in the long side direction W1. The laser light beam B0 therefore has an elliptical cross section BS perpendicular to the principal ray BLa.

The collimation system 12 includes a plurality of convex lenses 50 provided in correspondence with the semiconductor laser devices 40, as shown in FIG. 3. The convex lenses 50 each convert the corresponding laser light beam B0 into parallelized light. The collimation system 12 therefore converts a light beam flux K (which will be described later) outputted from the light source section 11 into parallelized light.

FIG. 5 is a side view of key parts of the light source apparatus 10 viewed in the direction −X. FIG. 6 is a plan view of the key parts of the light source apparatus 10 viewed in the direction −Z.

In the light source section 11, which is formed of the first light source section 11A and the second light source section 11B, when viewed in the direction parallel to the optical axis ax1, the 32 semiconductor laser devices 40 are arranged in a 4×8 matrix along the directions Z and X in the plane parallel to the plane XZ. That is, four device rows SL, which are each formed of 8 semiconductor laser devices 40 aligned along the direction X, are arranged in the direction Z. The direction in which the device rows SL extend (direction X) is hereinafter referred to as a device row direction. The arrangement of the spots of the plurality of laser light beams B0, which form the light beam flux K, is also a 4×8 matrix arrangement.

The light source section 11 outputs the light beam flux K containing the plurality of laser light beams B0, as shown in FIG. 3. The light beam flux K is formed of the plurality of laser light beams B0 emitted from the plurality of semiconductor laser devices 40 in the entire device rows SL. In the present embodiment, the width of the light beam flux K in the device row direction (direction X) is greater than the width of the light beam flux K in the direction perpendicular to the device row direction (direction Z). The cross section of the light beam flux K taken along a plane parallel to the plane XZ therefore can be approximately considered as an oblong having long sides in the direction X and short sides in the direction Z.

The number of device rows SL in the light source section 11 and the number of semiconductor laser devices 40 arranged along each of the device rows SL are presented by way of example and are not limited to the numbers described above. For example, in the present embodiment, the case where the light source section 11 is formed of the two light source sections (first light source section 11A and second light source section 11B) has been presented. Instead, the light source section 11 may be formed of one unit. Further, the number of device row SL only needs to be at least one.

The light beam flux compression system 13 is disposed in a position downstream of the collimation system 12, as shown in FIGS. 5 and 6. The light beam flux compression system 13 is an anamorphic light beam flux compression system on which the light beam flux K outputted from the light source unit 17 is incident, and the light beam flux compression system 13 anisotropically compresses the width of the incident light beam flux K and outputs the compressed light beam flux K.

The light beam flux compression system 13 is formed of the first cylindrical lens 13a and the second cylindrical lens 13b, which is provided in a position downstream of the first cylindrical lens 13a. The first cylindrical lens 13a has positive refracting power, as shown in FIG. 6. The second cylindrical lens 13b has negative refracting power. The first cylindrical lens 13a and the second cylindrical lens 13b are so disposed when viewed in the direction of the optical axis ax1 (direction Y) that the generatrix of the first cylindrical lens 13a is parallel to the generatrix of the second cylindrical lens 13b.

The light beam flux compression system 13 has maximum refracting power in the direction perpendicular to the generatrix of the first cylindrical lens 13a and has no refracting power in the direction parallel to the generatrix of the first cylindrical lens 13a. The direction perpendicular to the generatrix of the first cylindrical lens 13a and the optical axis ax1 is hereinafter referred to as a maximum refraction direction of the light beam flux compression system 13.

In the present embodiment, the light beam flux compression system 13 is so disposed that the maximum refraction direction is rotated from the direction perpendicular to the device row direction (direction Z) by a predetermined angle around the optical axis ax1, as shown in FIGS. 2, 5, and 6.

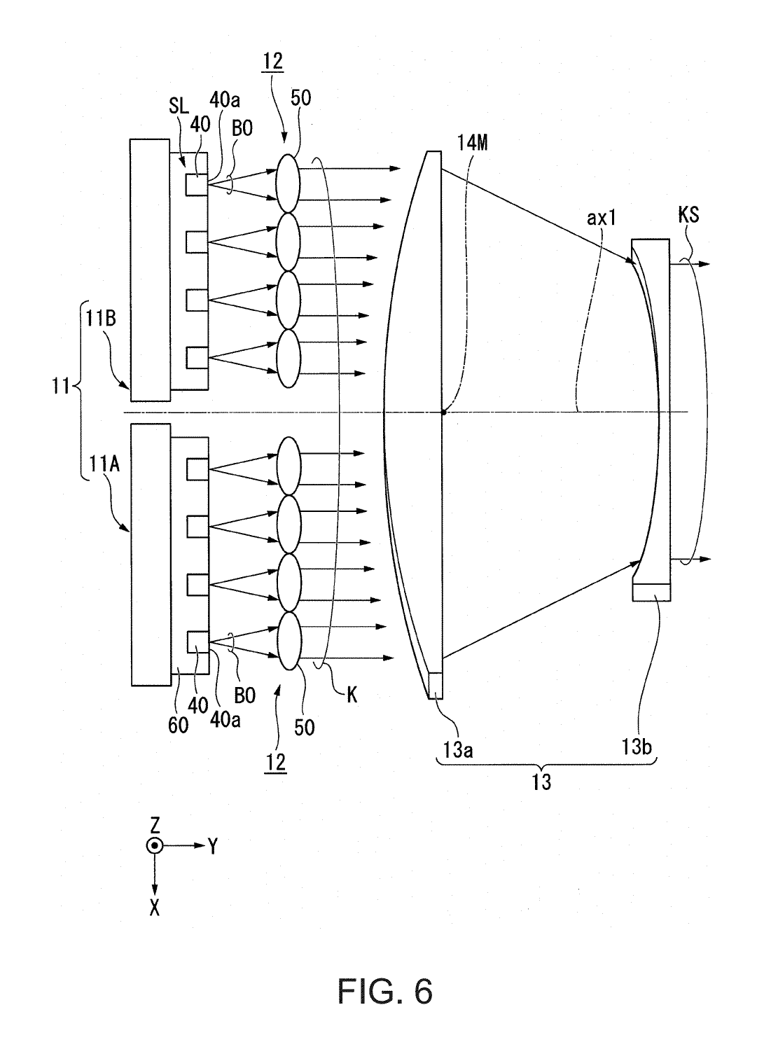

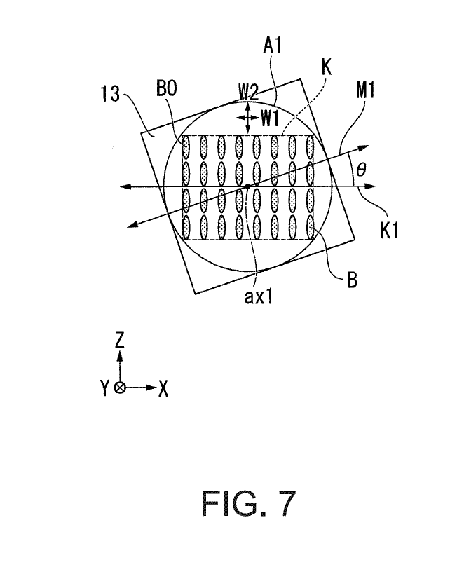

FIG. 7 shows the cross section of the light beam flux K in a position upstream of the light beam flux compression system 13 and the angle of rotation θ of the light beam flux compression system 13.

In a position upstream of the light beam flux compression system 13, the light beam flux K has a configuration in which the plurality of laser light beams B0 are two-dimensionally arranged, as shown in FIG. 7. In FIG. 7, the circle labeled with reference character A1 represents a minimum circular area necessary to capture the entire laser light beams B0.

Out of the major axis direction W2 and the minor axis direction W2 of the cross section of each of the plurality of laser light beams B0, the direction in which the light beam flux K is thicker than in the other direction is defined as a first direction. In this case, since the cross-sectional shape of the light beam flux K can be approximately considered as an oblong longer in the direction X than in the direction Z, the first direction is the arrowed direction labeled with reference character K1 (direction X). The first direction K1 is parallel to the minor axis direction W1.

In FIG. 7, the arrowed direction labeled with reference character M1 is the maximum refraction direction of the light beam flux compression system 13. Since the light beam flux compression system 13 is rotated around the optical axis ax1 of the light source section 11 as described above, the maximum refraction direction M1 of the light beam flux compression system 13 and the first direction K1 of the light beam flux K form a predetermined angle θ other than 0°, as shown in FIG. 7. The angle θ is hereinafter referred to as the angle of rotation θ. The angle of rotation θ is greater than 0° but smaller than 45°. The angle of rotation θ is preferably greater than or equal to 5° but smaller than or equal to 35°, more preferably greater than or equal to 5° but smaller than or equal to 15°.

A light beam flux KS having exited out of the light beam flux compression system 13 enters the homogenizing system 15, as shown in FIG. 2. The homogenizing system 15 has a configuration in which the first lens array 15a, the second lens array 15b, and the light collection lens 15c are provided in this order in positions downstream of the light beam flux compression system 13. As in the configuration example, another optical member may be provided between the second lens array 15b and the light collection lens 15c. The homogenizing system 15 homogenizes the intensity distribution of the light beam flux KS in a phosphor layer 33 of the wavelength converter 30, which is an illuminated area.

The first lens array 15a includes a plurality of lenses 15am arranged in a lattice along the directions X and Z in an plane XZ perpendicular to the optical axis ax1. The second lens array 15b includes a plurality of lenses 15bm arranged in a lattice along the directions X and Z in a plane XZ perpendicular to the optical axis ax1. The plurality of lenses 15bm correspond to the plurality of lenses 15am. The first lens array 15a has a plurality of lens rows each formed of a plurality of lenses, and the boundary line between two lens rows adjacent to each other out of the plurality of lens rows inclines with respect to the first direction K1 by 0° or 90°.

A light beam flux KL having exited out of the second lens array 15b is incident on the polarization separation element 23. The polarization separation element 23 is so disposed as to incline by 45° with respect to the optical axis ax1 and the illumination optical axis 100ax.

The polarization separation element 23 has a polarization separation function of separating the light beam flux KL incident on the polarization separation element 23 into the S-polarized component and the P-polarized component with respect to the polarization separation element 23. The polarization separation element 23 reflects the S-polarized light and transmits the P-polarized light. The light beam flux KL, which is S-polarized excitation light BLs, incident on the polarization separation element 23 is therefore reflected off the polarization separation element 23 and travels toward the retardation film 24. The polarization separation element 23 has further wavelength selection capability and transmits light (fluorescence YL) that belongs to a wavelength band different from the wavelength band to which the blue light beam flux KL belongs irrespective of the polarization state of the light.

The retardation film 24 is formed of a quarter wave plate disposed in the optical path between the polarization separation element 23 and the wavelength converter 30. The S-polarized excitation light BLs passes through the retardation film 24, which converts the S-polarized excitation light BLs into circularly polarized excitation light BLc, which is then incident on the light collection lens 15c. The light collection lens 15c causes the excitation light BLc to converge toward the phosphor layer 33 of the wavelength converter 30.

The wavelength converter 30 is formed of a reflective rotating fluorescent plate. That is, the wavelength converter 30 emits fluorescence YL toward the side on which the excitation light BLc is incident. The wavelength converter 30 includes the phosphor layer 33 having an annular shape and provided on a substrate 32, which can be rotated by a motor 31. The substrate 32 is formed, for example, of a disk made of a metal that excels in heat dissipation, such as aluminum and copper. The substrate 32 does not necessarily have a disk-like shape.

The phosphor layer 33 is excited by the excitation light BLc and emits yellow fluorescence YL containing red light and green light. The phosphor layer 33 is formed of a layer containing, for example, (Y,Gd)₃(Al,Ga)₅O₁₂:Ce, which is a YAG-based phosphor.

The wavelength converter 30 further includes a reflection layer 34 provided between the substrate 32 and the phosphor layer 33. The reflection layer 34 reflects the majority of the fluorescence YL produced in the phosphor layer 33 toward the side opposite the substrate 32. The fluorescence YL produced in the phosphor layer 33 thus exits toward the light collection lens 15c.

Out of the excitation light BLc, the components that have not been converted in terms of wavelength into the fluorescence YL are hereinafter referred to as excitation light BLcr. The excitation light BLcr is reflected off the reflection layer 34, passes through the light collection lens 15c, passes through the retardation film 24 again, which converts the excitation light BLcr into P-polarized light BLp, which is incident on the polarization separation element 23.

The yellow fluorescence YL emitted from the phosphor layer 33 toward the polarization separation element 23 passes through the light collection lens 15c, the retardation film 24, and the polarization separation element 23.

The blue P-polarized light BLp and the yellow fluorescence YL having passed through the polarization separation element 23 are combined with each other to produce the white illumination light WL. The illumination light WL passes through the polarization separation element 23 and then enters the homogenized illumination system 9 shown in FIG. 1.

The homogenized illumination system 9 includes a first lens array 125, a second lens array 130, a polarization conversion element 140, and a superimposing lens 150, as shown in FIG. 1.

The first lens array 125 includes a plurality of first lenses 125a for dividing the illumination light WL having exited out of the polarization separation element 23 into a plurality of sub-light beam fluxes. The plurality of first lenses 125a are arranged in a lattice in a plane YZ perpendicular to the illumination optical axis 100ax.

The second lens array 130 includes a plurality of second lenses 130a corresponding to the plurality of first lenses 125a of the first lens array 125. The second lens array 130, along with the superimposing lens 150, forms an image of each of the first lenses 125a of the first lens array 125 in the vicinity of an image formation area of each of the light modulators 400R, 400G, and 400B. The plurality of second lenses 130a are arranged in a lattice in a plane YZ perpendicular to the illumination optical axis 100ax.

The polarization conversion element 140 aligns the polarization directions of the illumination light WL to a linearly polarized light in one direction. The polarization conversion element 140 is formed of polarization separation layers, retardation layers, and reflection layers that are not shown. The polarization conversion element 140 converts the fluorescence YL, which is non-polarized light, into linearly polarized light.

The superimposing lens 150 collects the sub-light beam fluxes having exited out of the polarization conversion element 140 and superimposes the collected sub-light beam fluxes on one another in the vicinity of the image formation area of each of the light modulators 400R, 400G, and 400B.

In the light source apparatus 10 according to the present embodiment, in which the maximum refraction direction M1 of the light beam flux compression system 13 and the first direction K1 form the angle θ greater than 0° but smaller than 45°, the light beam flux KS in a position downstream of the light beam flux compression system 13 is narrower than the light beam flux K in a position upstream of the light beam flux compression system 13. Each optical system in a position downstream of the light beam flux compression system 13 can therefore be reduced in terms of size.

The arrangement of the spots of the plurality of laser light beams B0, which form the light beam flux K, changes from the matrix-like shape in a position upstream of the light beam flux compression system 13 to a distorted state in a position downstream of the light beam flux compression system 13. The uniformity of the illuminance distribution on the phosphor layer 33 of the wavelength converter 30 can therefore be increased.

To demonstrate the effects of the light source apparatus 10 according to the present embodiment, the present inventor has done a simulation to study the relationship between the angle of rotation θ of the light beam flux compression system 13 and the illuminance distribution on the phosphor layer 33.

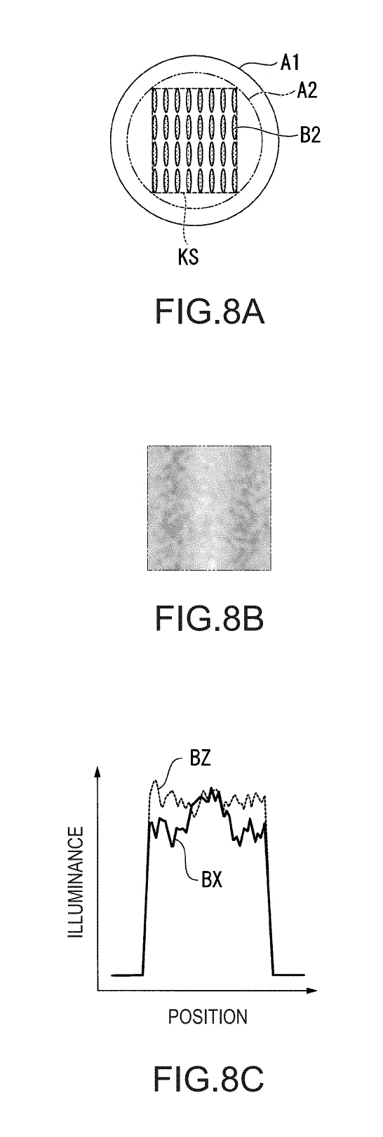

FIGS. 8A to 8C show results of the simulation in a case where the angle of rotation θ is set at 0°.

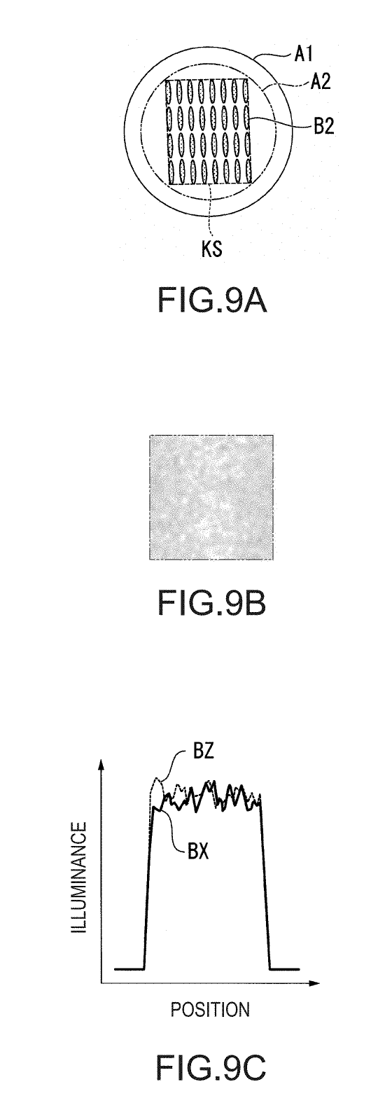

FIGS. 9A to 9C show results of the simulation in a case where the angle of rotation θ is set at 5°.

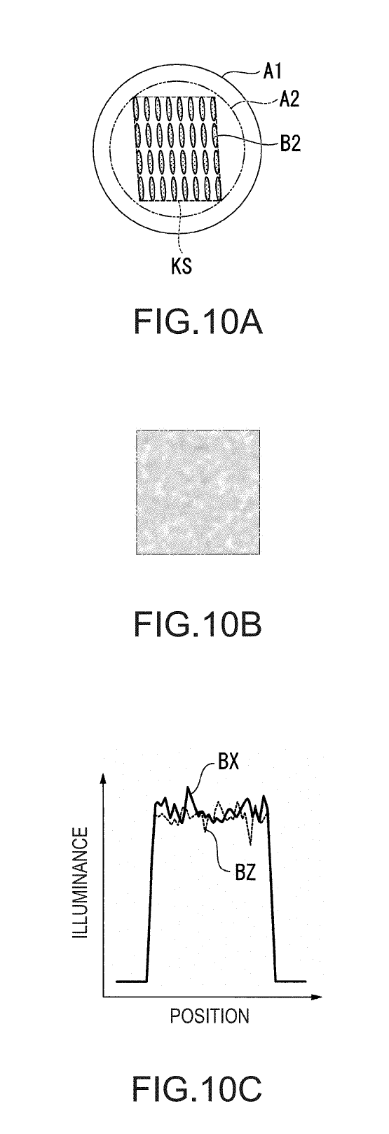

FIGS. 10A to 10C show results of the simulation in a case where the angle of rotation θ is set at 10°.

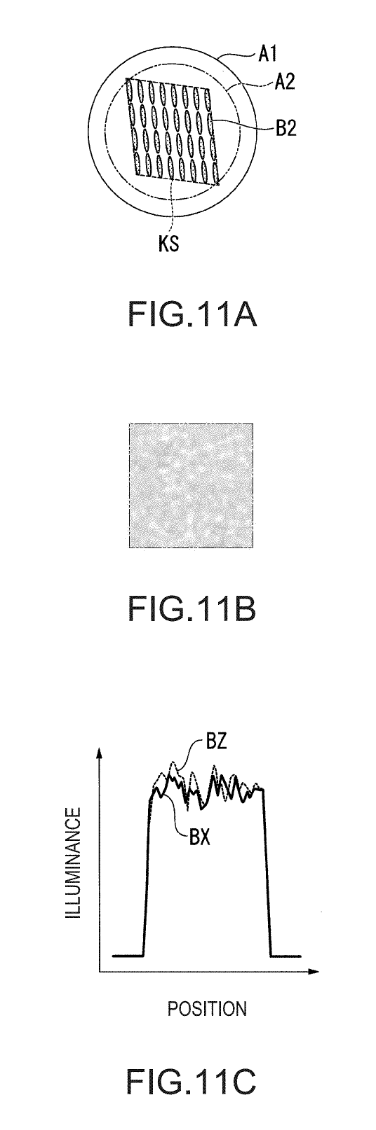

FIGS. 11A to 11C show results of the simulation in a case where the angle of rotation θ is set at 15°.

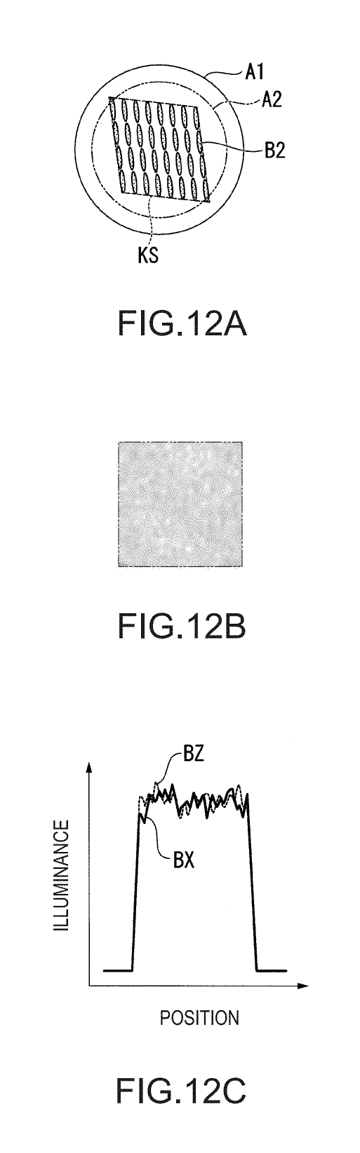

FIGS. 12A to 12C show results of the simulation in a case where the angle of rotation θ is set at 20°.

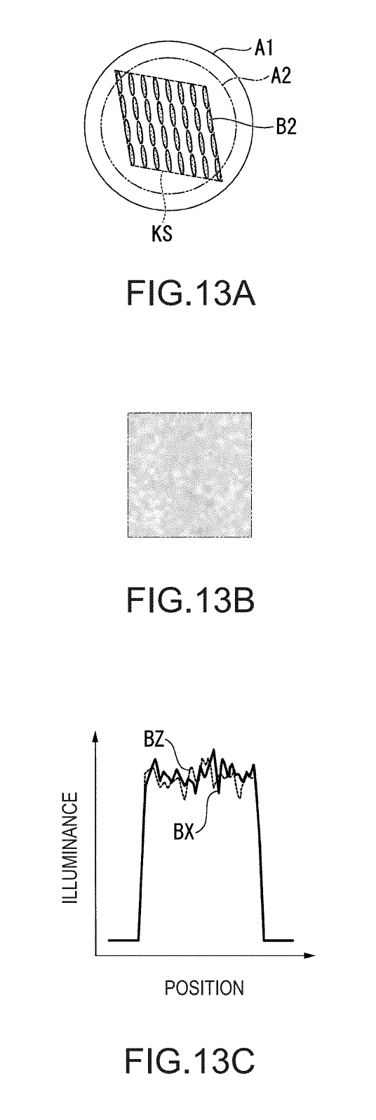

FIGS. 13A to 13C show results of the simulation in a case where the angle of rotation θ is set at 25°.

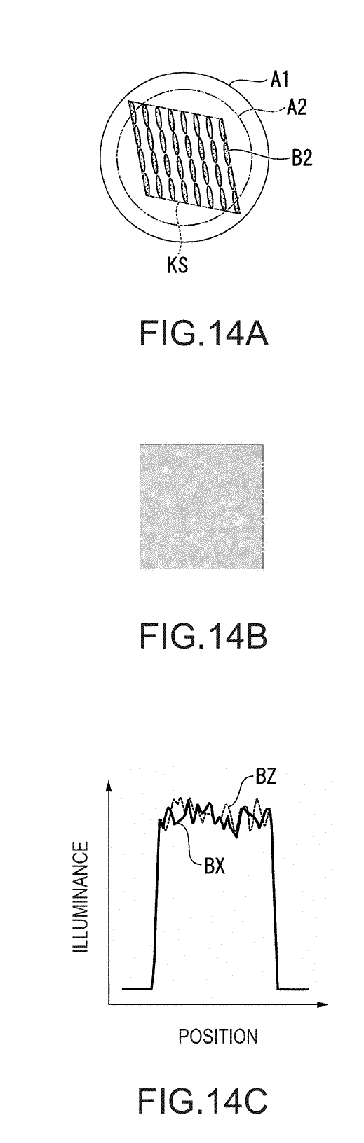

FIGS. 14A to 14C show results of the simulation in a case where the angle of rotation θ is set at 30°.

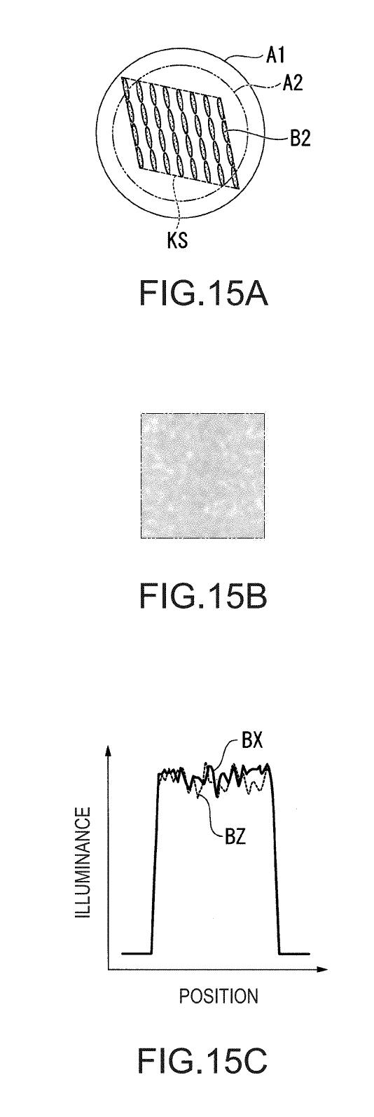

FIGS. 15A to 15C show results of the simulation in a case where the angle of rotation θ is set at 35°.

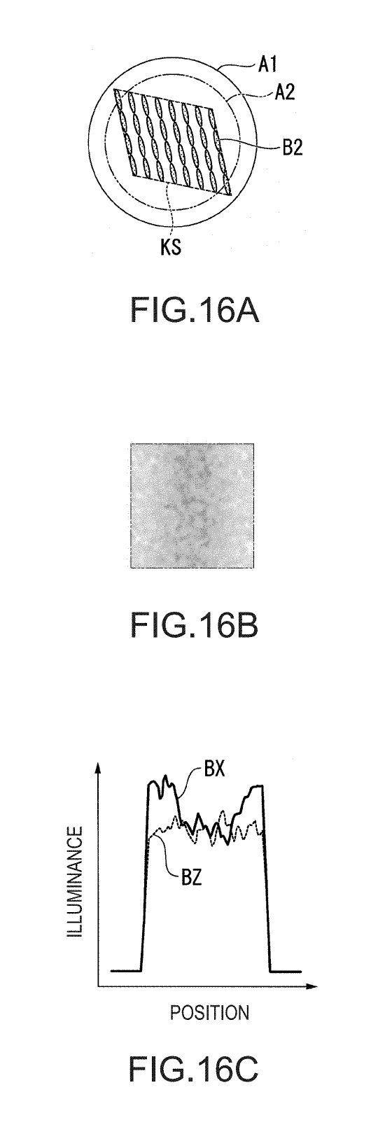

FIGS. 16A to 16C show results of the simulation in a case where the angle of rotation θ is set at 40°.

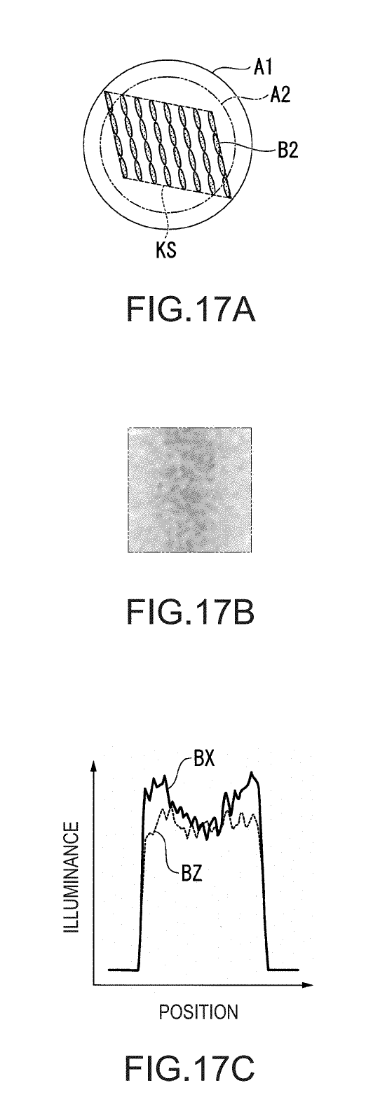

FIGS. 17A to 17C show results of the simulation in a case where the angle of rotation θ is set at 45°.

FIGS. 8A to 17A each show the cross section of the light beam flux in a position downstream of the light beam flux compression system 13, that is, the light beam flux after the compression. The circle labeled with reference character A1 in FIGS. 8A to 17A represents the minimum area necessary to capture the entire laser light beams that form the light beam flux K before the compression shown in FIG. 7 (hereinafter referred to as necessary minimum area A1). The circle labeled with reference character A2 represents the minimum area necessary to capture entire laser light beams B2 that form the light beam flux KS after the compression in the case where the angle of rotation is 0° (hereinafter referred to as necessary minimum area A2), as shown in FIG. 8A. That is, the circle A2 representing the necessary minimum area is a circle so drawn that the cross sections of the laser light beams B2 in the positions farthest from the center of the light beam flux KS (positions at corners of rectangular shape) are inscribed in the circle in the case where the angle of rotation is 0°.

FIGS. 8B to 17B each show the illuminance distribution in the illuminated area. The portion seen in white represents a high illuminance portion, and the portion seen in black represents a low illuminance portion.

FIGS. 8C to 17C each show graphs representing the illuminance distributions in the illuminated area. The horizontal axis of FIGS. 8C to 17C represents the position in the illuminated area [relative value], and the vertical axis thereof represents the illuminance [relative value]. The graph labeled with reference character BX represents the illuminance distribution in the device row direction (direction X), and the graph labeled with reference character BZ represents the illuminance distribution in the direction perpendicular to the device row direction (direction Z). The graphs each represent the illuminance distribution along the line passing through the center of the illuminated area.

In the case where the angle of rotation θ is set at 0°, the necessary minimum area A2 is smaller than the necessary minimum area A1, as shown in FIG. 8A. In this case, however, the illuminance distribution in the illuminated area has a large amount of unevenness, as shown in FIGS. 8B and 8C, which means that the uniformity of the illuminance distribution is insufficient.

In contrast, in the case where the angle of rotation θ is set at 5°, the cross-sectional shape of the light beam flux KS is so distorted as to be approximately considered as a parallelogram, as shown in FIG. 9A. Further, the arrangement of the spots of the plurality of laser light beams B2 is also distorted. The light beam flux KS, however, does not extend off the necessary minimum area A2. Therefore, the effect of reduction in the size of each optical system downstream of the light beam flux compression system 13 can be provided, as in the case where the angle of rotation θ is set at 0°. In addition to the above, the amount of unevenness of the illuminance distribution in the illuminated area is reduced and the uniformity of the illuminance distribution is therefore increased, as compared with the case where the angle of rotation θ is set at 0°, as shown in FIGS. 9B and 9C.

Also in the case where the angle of rotation θ is set at 10° or 15°, the effects of high uniformity of the illuminance distribution and size reduction are provided, as in the case where the angle of rotation θ is set at 5°, as shown in FIGS. 10A to 10C and FIGS. 11A to 11C.

In the case where the angle of rotation θ is set at 20°, the degree of the distortion of the spot arrangement slightly increases, and the light beam flux KS slightly extends off the necessary minimum area A2, as shown in FIG. 12A, but the degree of the extension is not so large as to hinder the effect of reduction in size of each optical system downstream of the light beam flux compression system 13. Further, the uniformity of the illumination distribution is maintained satisfactory, as shown in FIGS. 12B and 12C.

Also in the case where the angle of rotation θ is set at 25°, 30°, or 35°, the same results as those in the case where the angle of rotation θ is set at 20° are provided, as shown in FIG. 13A to 13C, 14A to 14C, or 15A to 15C.

In the case where the angle of rotation θ is set at 40°, the light beam flux KS extends off the necessary minimum area A2 by a further greater amount but is still smaller than the necessary minimum area A1, as shown in FIG. 16A, whereby the effect of reduction in size of each optical system downstream of the light beam flux compression system 13 is provided. The uniformity of the illuminance distribution is slightly lower than in the case where the angle of rotation θ is set at 35° but is acceptable, as shown in FIGS. 16B and 16C.

In the case where the angle of rotation θ is set at 45°, the uniformity roughly equal to that in the case where the angle of rotation θ is 40° is provided, as shown in FIGS. 17A to 17C. However, since the cross-sectional shape of the light beam flux KS is distorted too much, the effect of size reduction is not provided.

The results of the simulation described above indicate that the angle of rotation θ of the light beam flux compression system 13 needs to be greater than 0° but smaller than 45°, and that the angle of rotation θ is preferably greater than or equal to 5° but smaller than or equal to 35°, more preferably greater than or equal to 5° but smaller than or equal to 15°.

In the present embodiment, since the light beam flux compression system 13 includes the first cylindrical lens 13a having positive refracting power and the second cylindrical lens 13a having negative refracting power, and the generatrices of the two cylindrical lenses are parallel to each other, the light beam flux compression system 13 is allowed to have the maximum refraction direction in a simple configuration.

In the light source apparatus 10 according to the present embodiment, since the angle between the boundary line between adjacent lens rows of the first lens array 15a and the first direction K1 is 0° or 90°, the uniformity of the illuminance distribution can be further increased.

Since the light source apparatus 10 according to the present embodiment includes the wavelength converter 30 provided in a position downstream of the homogenizing system 15, illumination light having a desired color can be provided.

The projector 1 according to the present embodiment, which includes the light source apparatus 10 described above, excels in image quality and allows size reduction thereof.

The invention is not limited to the contents of the embodiment described above but can be changed as appropriate to the extent that the change does not depart from the substance of the invention.

For example, the aforementioned embodiment has been described with reference to the case where the yellow fluorescence provided by wavelength conversion of part of the blue light emitted from the semiconductor laser devices is combined with the remainder of the blue light that has not been converted in terms of wavelength to produce white light. The present invention may instead be applied to a light source apparatus in which the yellow fluorescence provided by wavelength conversion of the blue light emitted from the semiconductor laser devices is combined with blue light emitted from other semiconductor laser devices to produce white light. Further, the light source apparatus does not necessarily include the wavelength converter.

In the embodiment described above, the projector 1 including the three light modulators 400R, 400G, and 400B is presented by way of example. Instead, the invention is also applicable to a projector that uses a single light modulator to display color video images. The light modulators may each be a digital mirror device.

The embodiment described above shows the case where the light source apparatus according to the embodiment of the invention is used in a projector, but not necessarily. The light source apparatus according to the embodiment of the invention may be used in a lighting apparatus, such as a headlight of an automobile.

The entire disclosure of Japanese Patent Application No. 2017-094051, filed on May 10, 2017 is expressly incorporated by reference herein.

What is claimed is:

1. A light source apparatus comprising:
a light source unit including a light source section that includes a plurality of semiconductor laser devices and outputs a light beam flux formed of a plurality of laser light beams and a collimation system that parallelizes the light beam flux, the light source unit outputting the parallelized light beam flux;
an anamorphic light beam flux compression system on which the light beam flux outputted from the light source unit is incident; and
a homogenizing system formed of a first lens array, a second lens array, and a light collection lens provided in positions downstream of the light beam flux compression system in an order of the first lens array, the second lens array, and the light collection lens,
wherein in a position upstream of the light beam flux compression system, a major axis direction and a minor axis direction of a cross section of each of the plurality of laser light beams are so defined that one of the two directions in which the light beam flux is thicker than in another direction is a first direction, and a direction in which the light beam flux compression system has maximum refractive power is defined as a maximum refraction direction, and
an angle between the maximum refraction direction and the first direction is greater than 0° but smaller than 45°.

2. The light source apparatus according to claim 1,
wherein the plurality of semiconductor laser devices each have a light emitting area having a long side direction and a short side direction, and
the first direction is parallel to one of the long side direction and the short side direction.

3. The light source apparatus according to claim 1,
wherein the light beam flux compression system includes a first cylindrical lens having positive refracting power and a second cylindrical lens provided in a position downstream of the first cylindrical lens, and
a direction of a generatrix of the first cylindrical lens is parallel to a direction of a generatrix of the second cylindrical lens.

4. The light source apparatus according to claim 1, wherein the angle between the maximum refraction direction and the first direction is greater than or equal to 5° but smaller than or equal to 35°.

5. The light source apparatus according to claim 4, wherein the angle between the maximum refraction direction and the first direction is greater than or equal to 5° but smaller than or equal to 15°.

6. The light source apparatus according to claim 1,
wherein the first lens array has a plurality of lens rows each formed of a plurality of lenses, and
a boundary line between two lens rows adjacent to each other out of the plurality of lens rows inclines with respect to the first direction by 0° or 90°.

7. The light source apparatus according to claim 1, further comprising a wavelength converter provided in a position downstream of the homogenizing system.

8. A projector comprising:
the light source apparatus according to claim 1;
a light modulator that modulates light from the light source apparatus in accordance with image information to form image light; and
a projection system that projects the image light.

9. A projector comprising:
the light source apparatus according to claim 2;
a light modulator that modulates light from the light source apparatus in accordance with image information to form image light; and
a projection system that projects the image light.

10. A projector comprising:
the light source apparatus according to claim 3;
a light modulator that modulates light from the light source apparatus in accordance with image information to form image light; and
a projection system that projects the image light.

11. A projector comprising:
the light source apparatus according to claim 4;
a light modulator that modulates light from the light source apparatus in accordance with image information to form image light; and
a projection system that projects the image light.

12. A projector comprising:
the light source apparatus according to claim 5;
a light modulator that modulates light from the light source apparatus in accordance with image information to form image light; and
a projection system that projects the image light.

13. A projector comprising:
the light source apparatus according to claim 6;
a light modulator that modulates light from the light source apparatus in accordance with image information to form image light; and
a projection system that projects the image light.

14. A projector comprising:
the light source apparatus according to claim 7;
a light modulator that modulates light from the light source apparatus in accordance with image information to form image light; and
a projection system that projects the image light.
